(19) United States
(12) Patent Application Publication
(10) Pub. No.: US 2014/0168413 A1
(43) Pub. Date: Jun. 19, 2014

(54) WELDING INSPECTION SYSTEM AND METHOD

(71) Applicants: Kia Motors Corporation, Seoul (KR); Hyundai Motor Company, Seoul (KR)

(72) Inventor: Jae-Hyun Lee, Seoul (KR)

(73) Assignees: Kia Motors Corporation, Seoul (KR); Hyundai Motor Company, Seoul (KR)

(21) Appl. No.: 14/097,012

(22) Filed: Dec. 4, 2013

(30) Foreign Application Priority Data
Dec. 17, 2012 (KR) 10-2012-0147780

(51) Int. Cl. H04N 5/232

(52) U.S. Cl. CPC H04N 5/23229
USPC 348/90

(57) ABSTRACT

A welding inspection system for quality inspection may include a camera taking an image of an inspection target, a lighting irradiating a light onto the inspection target, a laser device irradiating a laser beam onto the inspection target from a side surface of the lighting, and a control unit controlling the camera, the lighting, and the laser device. A welding inspection method may include acquiring the image of the inspection target from the camera, separating the image acquired from the camera into RGB components, analyzing the image that has been separated into RGB components, and selecting a clearest result among analyzed results.

### CROSS-REFERENCE TO RELATED APPLICATION

The present application claims priority of Korean Patent Application Number 10-2012-0147780 filed Dec. 17, 2012, the entire contents of which application are incorporated herein for all purposes by this reference.

### BACKGROUND OF INVENTION

1. Field of Invention

The present invention relates to a welding inspection system and method, and more particularly, to a welding inspection system and method for transmission parts.

2. Description of Related Art

In general, welding inspection is inspection for a welded portion, and the shape of beads or the like is used to inspect a welding quality.

As the vehicle market competition deepens, the importance of quality has been gradually emphasized. That is, as the safety index, the motion index and the like become core elements of vehicle evaluation, a product having low durability cannot satisfy consumers even though the product has a low price and an excellent exterior. A welding process for transmission parts is an important element to determine the durability of a vehicle. When a transmission of which parts are not reliably welded is mounted in a vehicle, noise and a fatal accident may occur during operation.

Recently, a laser displacement sensor has been used in welding inspection for transmission parts. However, a large number of post processes are still performed. That is, welding results of the transmission parts need to be thoroughly inspected so as not to perform post processes for defective products. Therefore, the number of post processes needs to be reduced through thorough welding quality management.

Conventionally, welding inspection has been performed as follows: a laser displacement sensor is used to measure a welding bead and the measured value is compared to reference data.

However, the welding inspection using the laser displacement sensor depends only on a profile inspection. Therefore, measurement items are limited only to a bead height, and the precision of the inspection may be reduced. Further, as the laser displacement sensor uses a fixed lighting, the laser displacement sensor does not deal with shape change of an inspection target. Therefore, the inspection may be performed abnormally, which makes it impossible to guarantee the quality of finished products. In addition, as a large number of post processes are performed, the production cost may be increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide welding inspection system and method which are capable of improving precision of welding inspection. Further, the present invention has been made in an effort to provide welding inspection system and method which are capable of reducing a production cost.

Various aspects of the present invention provide a welding inspection system that inspects the quality of welding, including a camera taking an image of an inspection target, a lighting irradiating a light onto the inspection target, a laser device irradiating a laser beam onto the inspection target from a side surface of the lighting and a control unit controlling the camera, the lighting, and the laser device.

The camera may take the image in a direction substantially the same as a direction in which the lighting irradiates the light. The camera may include an auto-focusing lens to automatically adjust a focus.

The lighting may include a plurality of lamps which are mounted therein and of which irradiation angles are controlled, and the lighting may irradiate the light in various directions depending on the irradiation angles of the plurality of lamps. The plurality of lamps may independently control the irradiation angles. The plurality of lamps may include RGB.

The control unit may separate the image acquired from the camera into RGB components, and analyze separated images. The control unit may select the clearest result among results obtained by analyzing the separated images.

Various other aspects of the present invention provide a welding inspection method of a welding inspection system which includes a camera taking an image of an inspection target, a lighting irradiating a RGB light onto the inspection target, and a control unit controlling the camera and the lighting. The welding inspection method may include acquiring the image of the inspection target from the camera, separating the image acquired from the camera into RGB components, analyzing the image that has been separated into RGB components, and selecting a clearest result among analyzed results.

The analyzing of the image may include acquiring the image that has been separated into RGB components, and extracting the RGB components from the image. The analyzing of the image may further include thinning the extracted R component and extracting features to calculate a height of a bead.

The analyzing of the image may further include binarizing the extracted R, G, or B component or any combination thereof and removing noise to calculate a width and a position of a bead. The analyzing of the image may further include binarizing the extracted R, G, or B component or any combination thereof and removing noise to recognize a spatter and a hole.

The analyzing of the image may further include thinning a first extracted R component and extracting features to calculate a height of a bead, binarizing the extracted R component other than the first extracted R component, the extracted G component, the extracted B component or any combination thereof, performing a noise removal process on the binarized component or components, and calculating a width and a position of a bead or recognizing a spatter and a hole.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an exemplary welding inspection system according to the present invention.

FIG. 2 is a horizontal cross-sectional view of an exemplary lighting according to the present invention.

FIG. 3 is a vertical cross-sectional view of the exemplary lighting according to the present invention.

FIG. 4 is a partially-enlarged view of FIG. 3.

FIG. 5 is a flowchart of an exemplary welding inspection method according to the present invention.

FIG. 6 is a flowchart of an exemplary image analysis method according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

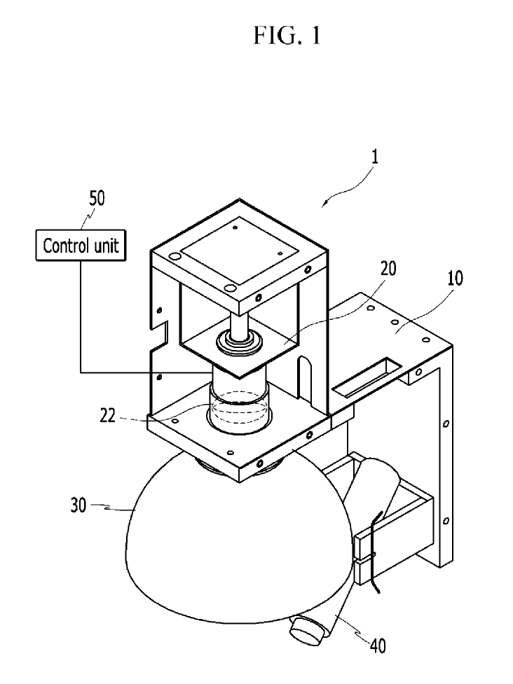

FIG. 1 is a perspective view of a welding inspection system according to various embodiments of the present invention. As shown in FIG. 1, the welding inspection system 1 includes a body unit 10, a camera 20, an auto-focusing lens 22, a lighting 30, a laser device 40, and a control unit 50.

The body unit 10 is the body of the welding inspection system 1 in which constituent elements forming the welding inspection system 1 are mounted or formed.

The camera 20 is a device for acquiring an image of an inspection target by photographing the inspection target. Further, the camera 20 is mounted at the top of the body unit 10. Here, the inspection target may include a welded surface. In addition, the camera 20 may include a color camera capable of taking a color image of the inspection target.

The auto-focusing lens 22 is a lens to automatically adjust a focus. Further, the auto-focusing lens 22 is mounted in the camera 20. That is, the auto-focusing lens 22 is mounted as a lens of the camera 20.

The lighting 30 is a device to irradiate light onto the inspection target when the camera 20 takes an image of the inspection target. Further, the lighting 30 is disposed under the camera 20, and mounted in the body unit 10. In addition, the lighting 30 is formed substantially in a hemispherical shape, and light is irradiated from a flat portion of the hemispherical shape. Meanwhile, the camera 20 is connected to the lighting 30, and the auto-focusing lens 22 is mounted in the same direction as a direction in which the light of the lighting 30 is irradiated, and takes an image in the same direction as the direction in which the light is irradiated.

The laser device 40 is disposed at a side surface of the lighting 30, and mounted in the body unit 10. Further, the laser device 40 irradiates a laser beam onto the inspection target from the side surface of the lighting 30.

The control unit 50 checks the contrast of the inspection target image acquired by the camera 20. Further, when the checked contrast does not satisfy a reference value, the control unit 50 controls the focus of the auto-focusing lens 22 such that the contrast of the inspection target image satisfies the reference value. In addition, depending on the intensity of a voltage applied to the auto-focusing lens 22, the focus of the auto-focusing lens 22 is changed.

Here, contrast is an amount indicating a difference between brightness and darkness. That is, contrast indicates a difference in luminance between the brightest portion and the darkest portion in an image.

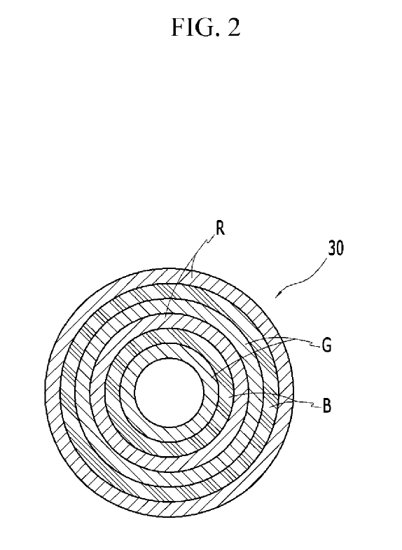

FIG. 2 is a horizontal cross-sectional view of the lighting according to various embodiments of the present invention. As shown in FIG. 2, the lighting 30 includes RGB (red, green, and blue). Further, in the lighting 30, the RGB is repetitively formed or alternates two or more times. In addition, the horizontal cross-section of the lighting 30 is formed substantially in a ring shape having a hollow portion therein. Meanwhile, the auto-focusing lens 22 of the camera 20 may be disposed in the hollow portion.

The RGB indicates red, green, and blue colors corresponding to the three primary colors of light, and RGB lamps of the lighting 30 Further, the RGB is widely used in a display device using light.

Meanwhile, the RGB scheme is a color display scheme to define a color using red, green, and blue. Further, the RGB scheme is a scheme to create a desired color by mixing red, green, and blue.

Colors created by the RGB scheme may include red (R), green (G), blue (B), yellow (R+G), magenta (R+B), cyan (B+G), and white (R+G+B). When none of the RGB is applied, black is created. That is, according to combinations of RGB, eight colors may be formed.

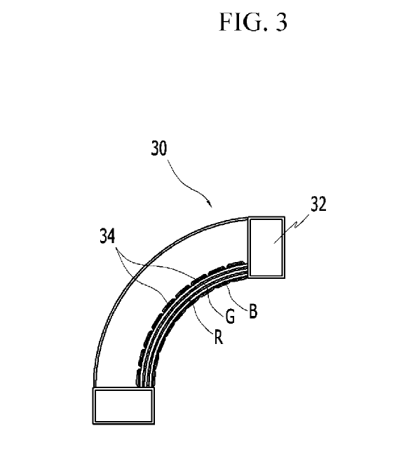

FIG. 3 is a vertical cross-sectional view of the lighting according to various embodiments of the present invention. As shown in FIG. 3, an RGB line of FIG. 2 is formed as a group of cells 34 including RGB lamps.

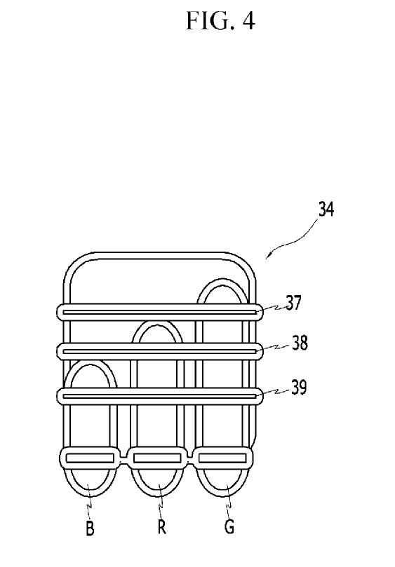

FIG. 4 is a partially-enlarged view of FIG. 3. Further, FIG. 4 illustrates one cell 34 of FIG. 3. As shown in FIG. 4, the cell 34 includes an R-lamp, a G-lamp, a B-lamp, an R-control socket 38, a G-control socket 37, and a B-control socket 39. That is, the R-lamp, the G-lamp, the B-lamp, the R-control socket 38, the G-control socket 37, and the B-control socket 39 are mounted in the cell 34.

The R-control socket 38, the G-control socket 37, the B-control socket 39 control the irradiation angles of the R-lamp, the G-lamp, and the B-lamp, respectively. Further, the irradiation angles of the R-lamp, the G-lamp, and the B-lamp are independently controlled by the R-control socket 38, the G-control socket 37, the B-control socket 39, respectively. In addition, the irradiation angle control for the RGB lamps is performed by the control unit 50.

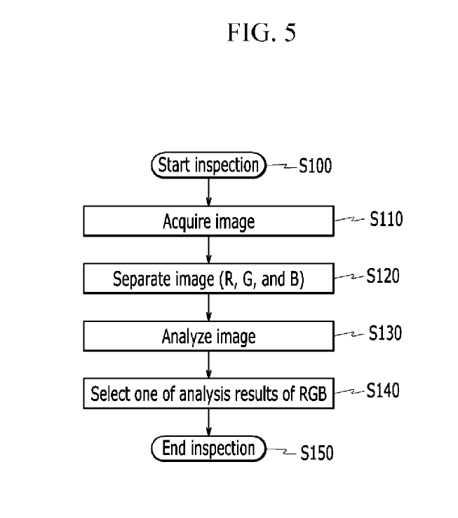

FIG. 5 is a flowchart of a welding inspection method according to various embodiments of the present invention. As shown in FIG. 5, the welding inspection system 1 is operated to start a welding inspection (S100). Then, the control unit 50 receives an image taken by the camera 20 (S110). That is, the control unit 50 acquires an image of an inspection target.

After the image of the inspection target is acquired, the control unit 50 separates the acquired image of the inspection target into R (red), G (green), and B (blue) components (S120).

After the image of the inspection target is separated into the R, G, and B components, the control unit 50 analyzes the image for the respective separated components (S130).

After the image of the inspection target is analyzed for the respective components, the control unit 50 selects an image of which the analysis result is the clearest, among the analyzed images (S140).

When the welding inspection is completed based on the image of which the analysis result is the clearest, the welding inspection method of the welding inspection system 1 is ended (S150).

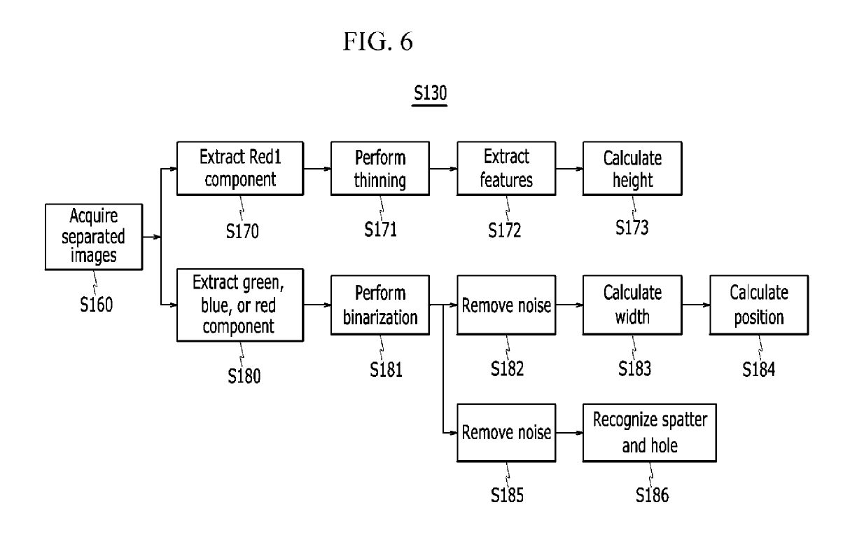

FIG. 6 is a flowchart of an image analysis method that can be used for quality inspection according to various embodiments of the present invention. As shown in FIG. 6, the step S130 includes the following steps.

When the image of the inspection target, separated into the R, G, and B components, is acquired (S160), the R, G, and B components are extracted (S170 and S180).

When a first R component is extracted (S170), the height of a bead is calculated (S173) through thinning (S171) and feature extraction (S172). Here, the bead refers to a belt-shaped long string formed by melting a base metal and a welding rod during a welding operation.

For components other than the first R component, steps different from the above-described steps S170, S171, S172, and S173 are performed.

When a G component, a B component, and a post-second R component (e.g. R component other than the first R component) are extracted (S180), binarization is performed (S181) on the extracted R, G, or B component or any combination thereof. Further, the binarized G component, B component, and/or post-second R component are subjected to a noise removal process (S182), and the width of the bead is then calculated (S183). Then, the position of the bead is calculated (S184). Meanwhile, the binarized G component, B component, and/or post-second R component are subjected to another noise removal process (S185), and a spatter and a hole are recognized (S186). The spatter indicates a flaw which is formed when liquid permeates into a welded surface, and the hole indicates a flaw of a welded surface which is formed by bubbles.

The series of processes of FIG. 6 are performed by the control unit 50.

According to the present invention, the height of a bead, the width of the bead, the position of the bead, and holes are included in the measurement items, which makes it possible to improve the precision of welding inspection. Further, as the lighting 30 irradiates light at various angles, it is possible to easily deal with the shape change of the inspection target. In addition, the welding inspection system 1 is less expensive than the laser displacement sensor, and the number of post processes is reduced. Therefore, the production cost may be reduced.

For convenience in explanation and accurate definition in the appended claims, the terms “horizontal” or “vertical”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A welding inspection system for quality inspection of welding, comprising:
a camera taking an image of an inspection target;
a lighting irradiating a light onto the inspection target;
a laser device irradiating a laser beam onto the inspection target from a side surface of the lighting; and
a control unit controlling the camera, the lighting, and the laser device.

2. The welding inspection system of claim 1, wherein the camera takes the image in a direction substantially the same as a direction in which the lighting irradiates the light.

3. The welding inspection system of claim 2, wherein the camera comprises an auto-focusing lens to automatically adjust a focus.

4. The welding inspection system of claim 1, wherein:
the lighting comprises a plurality of lamps which are mounted therein and of which irradiation angles are controlled, and
the lighting irradiates the light in various directions depending on the irradiation angles of the plurality of lamps.

5. The welding inspection system of claim 4, wherein the plurality of lamps independently control the irradiation angles.

6. The welding inspection system of claim 4, wherein the plurality of lamps comprise RGB.

7. The welding inspection system of claim 6, wherein the control unit separates the image acquired from the camera into RGB components, and analyzes separated images.

8. The welding inspection system of claim 7, wherein the control unit selects a clearest result among results obtained by analyzing the separated images.

9. A welding inspection method of a welding inspection system which includes a camera taking an image of an inspection target, a lighting irradiating a RGB light onto the inspection target, and a control unit controlling the camera and the lighting, the welding inspection method comprising:
acquiring the image of the inspection target from the camera;
separating the image acquired from the camera into RGB components;
analyzing the image that has been separated into RGB components; and
selecting a clearest result among analyzed results.

10. The welding inspection method of claim 9, wherein the analyzing of the image comprises:
acquiring the image that has been separated into RGB components; and
extracting the RGB components from the image.

11. The welding inspection method of claim 10, wherein the analyzing of the image further comprises thinning the extracted R component and extracting features to calculate a height of a bead.

12. The welding inspection method of claim 10, wherein the analyzing of the image further comprises binarizing the extracted R, G, or B component or any combination thereof and removing noise to calculate a width and a position of a bead.

13. The welding inspection method of claim 10, wherein the analyzing of the image further comprises binarizing the extracted R, G, or B component or any combination thereof and removing noise to recognize a spatter and a hole.

14. The welding inspection method of claim 10, wherein the analyzing of the image further comprises:
thinning a first extracted R component and extracting features to calculate a height of a bead;
binarizing the extracted R component other than the first extracted R component, the extracted G component, the extracted B component or any combination thereof;
performing a noise removal process on the binarized component or components; and
calculating a width and a position of a bead or recognizing a spatter and a hole.
